(19) United States
(12) Patent Application Publication
(10) Pub. No.: US 2026/0058173 A1
(43) Pub. Date: Feb. 26, 2026

(54) OPERATING METHOD FOR OPERATING A FUEL CELL SYSTEM

(71) Applicant: Robert Bosch GmbH, Stuttgart (DE)

(72) Inventors: Tobias Falkenau, Esslingen (DE); Simon Buehler, Stuttgart (DE); Stephan Strahl, Hamburg (DE)

(21) Appl. No.: 19/105,088

(22) PCT Filed: Sep. 7, 2023
(86) PCT No.: PCT/EP2023/074620

§ 371 Date: Feb. 20, 2025

(30) Foreign Application Priority Data
Sep. 8, 2022 (DE) 10 2022 209 334.8

(51) Int. Cl. H01M 8/04225; H01M 8/04089; H01M 8/04223; H01M 8/04228; H01M 8/04302; H01M 8/04303; H01M 16/00

(52) U.S. Cl. CPC H01M 8/04225; H01M 8/04089; H01M 8/04228; H01M 8/04231; H01M 8/04302; H01M 8/04303; H01M 16/003; H01M 2250/20

(57) ABSTRACT

The invention relates to an operating method (100) for operating a fuel cell system (300) for providing electrical energy for a consumer. The operating method (100) comprises the steps of activating (101) a shut-down procedure of the fuel cell system (300) in response to the receipt of a shut-down command. The shut-down procedure comprises shutting down an air supply unit (305) for supplying air to a cathode sub-system (303) of the fuel cell system (300) in order to reduce oxygen introduced to the cathode sub-system (303) and a voltage provided by the fuel cell system (300), activating (103) a reactivation procedure of the fuel cell system (300) in response to a receipt of a start-up command, if the start-up command is received within a predefined time period after the shut-down command, wherein the reactivation procedure involves increasing the speed of the air supply unit (305) directly after receipt of the start-up command.

### BACKGROUND

The present invention relates to an operating method, a fuel cell system, and a vehicle according to the disclosure.

Fuel cells convert hydrogen and oxygen to water, generating electricity that can be supplied to a consumer, such as an electric motor, in order to drive it.

To supply oxygen to a fuel cell, its cathode is typically supplied with ambient air provided by a compressor.

The heat dissipation of the process waste heat is usually carried out by liquid cooling. The cooling medium is typically conveyed with an electrically driven transfer pump.

To optimize the reaction temperature in the fuel cell system, electric heaters are used at various locations.

All of these auxiliary consumers may be supplied directly from the fuel cell for efficiency reasons or may be supplied at a different voltage level via a voltage converter.

When shutting down a fuel cell system, it is necessary to reduce the voltage and reactants. Advantageously, the fuel cell system is conditioned such that an optimal shut-down state with defined moisture content, oxygen concentration and hydrogen concentration is set on the anode and cathode side.

Known procedures require time to set a shut-down state for conditioning the fuel cell system, so that if a request for a restart is made during conditioning, the complete shut-down and conditioning phase of the fuel cell system must first be waited for, which is energy inefficient.

### SUMMARY

Presented in the context of the invention are an operating method for operating a fuel cell system, a fuel cell system and a vehicle. Further features and details of the invention arise from the respective dependent claims, the description, and the drawings. In this context, features and details described in connection with the operating method according to the invention clearly also apply in connection with the fuel cell system according to the invention or the vehicle according to the invention, and respectively vice versa, so that mutual reference to the individual considerations of the invention always is or can be made with respect to the disclosure.

In particular, the invention presented serves to enable a fast restart of a fuel cell system during a shut-down procedure.

Therefore, according to a first aspect of the invention presented, an operating method for operating a fuel cell system for providing electrical energy for a consumer is presented. The operating method comprises activating a shut-down procedure of the fuel cell system in response to receipt of a shut-down command, wherein the shut-down procedure comprises shutting down an air supply unit for supplying air to a cathode sub-system of the fuel cell system in order to reduce oxygen introduced to the cathode sub-system and a voltage provided by the fuel cell system, activating a reactivation procedure of the fuel cell system in response to a receipt of a start-up command, if the start-up command is received within a predefined time period after the shut-down command, and wherein the reactivation procedure involves increasing the speed of the air supply unit directly after receipt of the start-up command.

In the context of the invention presented, a shut-down procedure is to be understood as a process in which a fuel cell system is transferred under controlled conditions to a deactivated state in which, for example, residual oxygen in a cathode sub-system is broken down by hydrogen in an anode sub-system or converted to water until a voltage in a fuel cell stack falls below a predefined threshold value due to lack of oxygen.

The operating method presented is based on the principle that during a shut-down procedure of a fuel cell system, a command to start the fuel cell system is triggered, i.e., a restart that results in a restart of the fuel cell system within a short time period after an operating phase is performed.

In order to minimize a time until the fuel cell system is used after restart, the invention provides that an air supply unit of the fuel cell system is actuated in such a way that it increases its speed up to a minimum speed and accordingly blows fresh air with additional oxygen into a cathode sub-system of the fuel cell system, such that a voltage provided by a fuel cell stack of the fuel cell system increases and the air supply unit and all other auxiliary units of the fuel cell system can be supplied with sufficient voltage for operation by the fuel cell stack.

By increasing the speed of the air supply unit directly after receipt of the start-up command, as provided by the invention, the shut-down procedure is interrupted and the reactivation procedure is triggered, such that a time until the fuel cell system or a consumer supplied by the fuel cell system is operated again is reduced compared to a procedure in which the fuel cell system is fully deactivated and reactivated. The operating method presented utilizes the inertia of a mass air flow that still travels through the fuel cell system after shut-down of the air supply unit in order to increase a voltage applied in the fuel cell stack and to restart the air supply unit.

In particular, it may be provided that the speed of the air supply unit is increased by means of electrical energy generated by a fuel cell stack of the fuel cell system during the shut-down procedure.

Since there is a residual voltage on the fuel cell stack of the fuel cell system due to the air flow still flowing through the fuel cell system after the air supply unit has been shut down, this voltage may be used to activate the air supply unit and convey fresh air into the fuel cell system, such that the voltage applied to the fuel cell stack increases to a voltage intended for operation of the fuel cell system and the fuel cell system switches to regular operation or normal operation.

It may be further provided that the speed of the air supply unit is increased by means of a battery storage device electrically coupled to the fuel cell system.

In the event that the voltage applied to the fuel cell stack is insufficient to activate the air supply unit, a battery storage device, such as a battery from an on-board power system of a vehicle comprising the fuel cell system, may be used to supply electrical power to the air supply unit until sufficient voltage is applied to the fuel cell stack and to operate the air supply unit through the fuel cell stack.

It may be further provided that the electrical energy is supplied to the air supply unit via a DC/DC converter of the fuel cell system, the current direction of which is reversed with respect to the shut-down procedure.

In the event that the air supply unit is supplied with electrical energy via a DC/DC converter and is connected in parallel to the fuel cell stack, for example, the DC/DC converter may be used to supply the air supply unit with electrical energy from a battery, for example, and to adjust a voltage accordingly to a voltage required by the air supply unit.

It may further be provided that cathode shut-down valves of the fuel cell system may be closed in response to the receipt of the shut-down command and that cathode shut-down valves may be opened in response to the receipt of the start-up command.

When cathode shut-down valves are closed during a shut-down procedure, they must be opened during a reactivation procedure to provide fresh air to the fuel cell stack.

It may be provided that a gross output of the fuel cell system during the increase in the speed of the air supply unit is greater than a net output of the fuel cell system.

Since during the reactivation procedure the auxiliary units of the fuel cell system, in particular the air supply unit, are supplied with energy, a net power of the fuel cell system during the reactivation procedure is typically negative so that the fuel cell system consumes more power than it provides.

According to a second aspect, the invention presented relates to a fuel cell system for supplying electrical energy for electrical consumers. The fuel cell system presented includes a fuel cell stack, a cathode sub-system, an air supply unit for supplying air to the cathode sub-system, a computing unit, and a user interface. The computing unit is configured to perform a possible configuration of the presented operating method.

In the context of the invention presented, a computing unit is understood to mean a computer, a processor, a control device, or any other programmable circuit.

It may be provided that that the computing unit is configured to activate a shut-down procedure of the fuel cell system in response to a shut-down command triggered by the user interface, wherein the shut-down procedure is configured to transmit a control command to the air supply unit that shuts down the air supply unit in order to reduce oxygen introduced into the cathode sub-system and a voltage provided by the fuel cell stack, and wherein the computing unit is further configured to activate a reactivation procedure of the fuel cell system in response to a start-up command triggered by the user interface within a predefined time period after the shut-down command, wherein the reactivation procedure configures the computing unit to transmit a control command to the air supply unit directly after the triggering of the start-up command that causes the speed of the air supply unit to increase to a minimum speed.

It may further be provided that the reactivation procedure configures the computing unit to supply electrical energy from an energy store to the air supply unit directly after the triggering of the start-up command if a voltage supplied by the fuel cell stack is below a predefined threshold value.

The energy store for supplying electrical energy to the air supply unit may be, for example, a battery of a vehicle comprising the presented fuel cell system or a battery of the fuel cell system itself.

According to a third aspect, the invention presented relates to a vehicle comprising a possible embodiment of the invention presented.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 a schematic representation of a possible configuration of the operating method presented,

FIG. 2 a detailed representation of the operating method according to FIG. 1,

FIG. 3 a possible configuration of the presented fuel cell system in a possible configuration of the presented vehicle.

### DETAILED DESCRIPTION

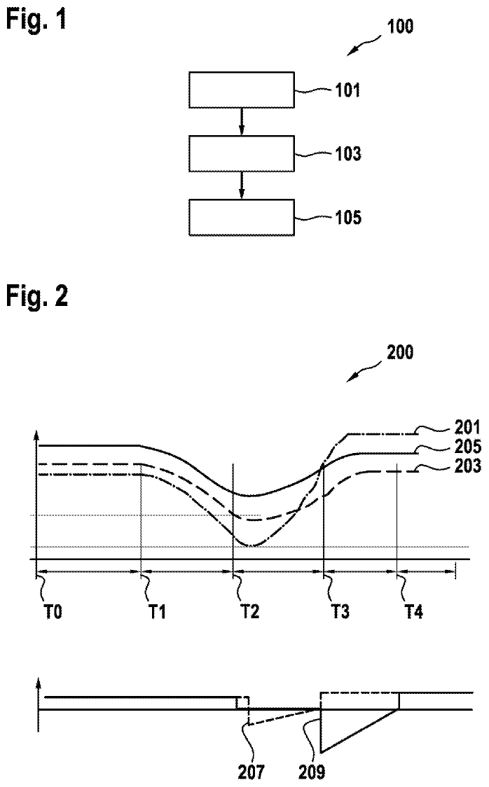

In FIG. 1, an operating method 100 for operating a fuel cell system for providing electrical energy for a consumer is shown.

The operating method 100 comprises a first activation step 101 in which a shut-down procedure of the fuel cell system is activated in response to the receipt of a shut-down command. The shut-down procedure comprises shutting down an air supply unit for supplying air to a cathode sub-system of the fuel cell system in order to reduce oxygen introduced into the cathode sub-system and a voltage provided by the fuel cell system.

Furthermore, the operating method 100 comprises a second activation step 103 in which a reactivation procedure of the fuel cell system is activated in response to the receipt of a start-up command, if the start-up command is received within a predefined time period after the shut-down command. The reactivation procedure comprises a control step 105 in which the air supply unit is actuated directly after the receipt of the start-up command to increase its speed to a minimum speed. To this end, the air supply unit may be supplied with, for example, electrical energy from a fuel cell stack of the fuel cell system and/or with electrical energy from a battery.

FIG. 2 shows a graph 200 depicting a time plot 201 of a voltage applied to the fuel cell stack, a time plot 203 of an air supply unit speed, and a time plot 205 of an electrical current provided by the fuel cell stack.

Starting from a time T0 to a time T1, normal operation of the fuel cell system is carried out, wherein voltage, speed and current are controlled to constant values.

At time T1, a user triggers a shut-down command and activates the shut-down procedure of the fuel cell system such that, for example, cathode shut-off valves of the fuel cell system are closed and the speed of the air supply unit decreases. Accordingly, the voltage applied to the fuel cell stack and the supplied electrical current also drop in a so-called “bleed down”, i.e., an operation in which residual oxygen in the fuel cell system is converted to water.

At a time T2, a start-up command is triggered by the user within a predefined time period after the time T1 by a so-called “change of mind” event and the reactivation procedure of the fuel cell system is activated such that the air supply unit is supplied with electrical energy or voltage and its speed increases accordingly, which in turn increases the electrical current provided and the voltage applied to the fuel cell stack, until at a time T3 a so-called “optimized operation”, i.e., an operation with operating conditions optimized for a start-up of the fuel cell system, is achieved. At a time T4, when there is sufficient control reserve for the cathode air quantity, a normal power-controlled control strategy is activated.

A plot 207 shows a current flow through the DC/DC converter according to the operating method 100 shown in FIG. 1.

A plot 209 shows a current flow through a DC/DC converter in a normal operation, when the fuel cell system is completely shut down.

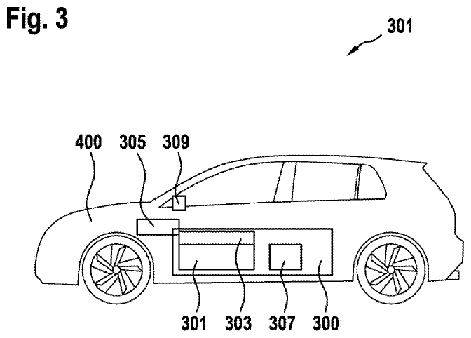

FIG. 3 shows a vehicle 400 with a fuel cell system 300. The fuel cell system 300 includes a fuel cell stack 301, a cathode sub-system 303, an air supply unit 305 for supplying air to the cathode sub-system 303, a computing unit 307, and a user interface 309.

The computing unit 307 is configured to perform the operating method 100 when a start-up command for restarting or activating a restart procedure of the fuel cell system 300 occurs via the user interface 309 within a predetermined time period after a shut-down command of the fuel cell system.

1. An operating method (100) for operating a fuel cell system (300) for providing electrical energy for a consumer,
the operating method (100) comprises:
activating (101) a shut-down procedure of the fuel cell system (300) in response to the receipt of a shut-down command,
wherein the shut-down procedure comprises shutting down an air supply unit (305) for supplying air to a cathode sub-system (303) of the fuel cell system (300) to reduce oxygen introduced into the cathode sub-system (303) and a voltage provided by the fuel cell system (300),
activating (103) a reactivation procedure of the fuel cell system (300) in response to the receipt of a start-up command, if the start-up command is received within a predefined time period after the shut-down command,
wherein the reactivation procedure involves:
increasing the speed of the air supply unit (305) up to a minimum speed,
directly after receipt of the start-up command.

2. The operating method (100) according to claim 1, wherein
increasing the speed of the air supply unit (305) is performed by means of electrical energy generated by a fuel cell stack (301) of the fuel cell system (300) during the shut-down procedure.

3. The operating method (100) according to claim 1, wherein
the speed of the air supply unit (305) is increased by means of a battery storage device electrically coupled to the fuel cell system (300).

4. The operating method (100) according to claim 3, wherein
the electrical energy is supplied to the air supply unit (305) via a DC/DC converter of the fuel cell system (300), the current direction of which is reversed with respect to the shut-down procedure.

5. The operating method (100) according to claim 1, wherein
cathode shut-down valves of the fuel cell system (300) are closed in response to the receipt of the shut-down command, and
cathode shut-down valves are opened in response to the receipt of the start-up command.

6. The operating method (100) according to claim 1, wherein
a gross output of the fuel cell system (300) during the increase in the speed of the air supply unit (305) is greater than a net output of the fuel cell system (300).

7. A fuel cell system (300) for providing electrical energy for a consumer,
wherein the fuel cell system (300) comprises the following:
a fuel cell stack (301),
a cathode sub-system (303),
an air supply unit (305) for supplying the cathode sub-system (303) with air,
a computing unit (307),
a user interface (309),
wherein the computing unit (307) is configured to
activate (101) a shut-down procedure of the fuel cell system (300) in response to the receipt of a shut-down command,
wherein the shut-down procedure comprises shutting down an air supply unit (305) for supplying air to a cathode sub-system (303) of the fuel cell system (300) to reduce oxygen introduced into the cathode sub-system (303) and a voltage provided by the fuel cell system (300),
activate (103) a reactivation procedure of the fuel cell system (300) in response to the receipt of a start-up command, if the start-up command is received within a predefined time period after the shut-down command,
wherein the reactivation procedure involves:
increasing the speed of the air supply unit (305) up to a minimum speed, directly after receipt of the start-up command.

8. The fuel cell system (300) according to claim 7, wherein
the computing unit (307) is configured to
activate a shut-down procedure of the fuel cell system (300) in response to a shut-down command triggered by the user interface (309),
wherein the shut-down procedure configures the computing unit (307) to transmit a control command to the air supply unit (305) that shuts down the air supply unit (305) in order to reduce oxygen introduced into the cathode sub-system (303) and a voltage provided by the fuel cell stack (301) and wherein the computing unit (307) is further configured to activate a reactivation procedure of the fuel cell system (300) in response to a start-up command triggered by the user interface (309) within a predefined time period after the shut-down command,
wherein the reactivation procedure configures the computing unit (307) to transmit a control command to the air supply unit (305) that causes an increase in the speed of the air supply unit (305) to a minimum speed directly after the start-up command is triggered.

9. The fuel cell system (300) according to claim 8, wherein
the reactivation procedure configures the computing unit (307) to supply electrical energy from an energy store to the air supply unit (305) directly after triggering the start-up command if a voltage provided by the fuel cell stack (301) is below a predefined threshold value.

10. A vehicle (400) having one fuel cell system (300) according to claim 7.
